(19) United States
(12) Patent Application Publication
(10) Pub. No.: US 2012/0207486 A1
(43) Pub. Date: Aug. 16, 2012

(54) IMAGE FORMING APPARATUS PROVIDED WITH CONVEYANCE UNIT

(75) Inventors: Keisuke EGAWA, Osaka-shi (JP); Terumitsu NOSO, Osaka-shi (JP)

(73) Assignee: Kyocera Mita Corporation, Osaka-shi (JP)

(21) Appl. No.: 13/396,684

(22) Filed: Feb. 15, 2012

(30) Foreign Application Priority Data
Feb. 16, 2011 (JP) 2011-031105
Jul. 25, 2011 (JP) 2011-161891

(51) Int. Cl. G03G 21/16

(52) U.S. Cl. 399/21; 399/124

(57) ABSTRACT

An image forming apparatus includes an apparatus body, a conveyance unit withdrawably mounted on the apparatus body, and a driving mechanism disposed in the apparatus body. The conveyance unit has a power transmission member which transmits the driving force generated by the driving mechanism to the conveyance member. The power transmission member has a drive input section disposed on the outside of a housing for receiving the driving force. The driving mechanism is disposed on the apparatus body side, and has a drive output section engageable with the drive input section. The drive input section and the drive output section engage with each other in a mounted state that the conveyance unit is mounted on the apparatus body, and the engagement between the drive input section and the drive output section is released in a withdrawn state that the conveyance unit is withdrawn from the apparatus body.

This application is based on Japanese Patent Application No. 2011-031105 filed on Feb. 16, 2011, and Japanese Patent Application No. 2011-161891 filed on Jul. 25, 2011, the contents of which are hereby incorporated by reference.

### BACKGROUND

The present disclosure relates to an image forming apparatus provided with a conveyance unit which is withdrawable from an apparatus body for conveying a sheet.

A certain type of image forming apparatus is provided with a conveyance unit for horizontally conveying a sheet. One of such an image forming apparatus has a layout that a fixing device is disposed on one side surface of an apparatus body of the image forming apparatus, and a sheet ejecting tray or a post-processing device for performing a stapling operation or the like is disposed on the other side surface of the apparatus body. In this arrangement, a conveyance unit for conveying a sheet to be outputted from the fixing device toward the sheet ejecting tray or the post-processing device is mounted on the apparatus body.

The conveyance unit having the above arrangement is required to have at least a function of conveying sheets, preferably, a function of detecting a sheet jam, and additionally, the operability of causing a user to easily remove a jammed sheet. In view of the above, the conveyance unit is equipped with a conveyance roller for giving a conveyance force to a sheet, and a sheet detecting sensor for detecting the presence or absence of the sheet in a sheet conveyance path formed in the conveyance unit; and the conveyance unit is withdrawably mounted on the apparatus body so that the user is caused to remove a jammed sheet.

The conventional conveyance unit is loaded with a motor for giving a rotational driving force to the conveyance roller, and a main part of a sheet detecting sensor such as a photointerruptor. It is indispensable to provide wirings which electrically connect these devices to a power source device or a control board of the apparatus body for electric power supply or signal transmission. In view of the above, there is used an arrangement that a drawer connector is provided for each of the apparatus body and the conveyance unit, the drawer connectors are connected to each other in a state that the conveyance unit is mounted on the apparatus body, and the connection between the drawer connectors is released in a state that the conveyance unit is withdrawn from the apparatus body.

In the conventional conveyance unit, it is required to load a motor, a sheet detecting sensor, and wirings for these devices on a unit housing, and also mount drawer connectors on the unit housing. This may give rise to an increase in the number of parts constituting the image forming apparatus, and an increase in the cost of the image forming apparatus. Further, static electricity generated by the user may be ejected when the user tries to withdraw the conveyance unit. If the wirings extend up to the position where the conveyance unit is mounted, the static electricity may enter the apparatus body via the wirings and the drawer connectors, which may adversely affect the electrical components in the apparatus body.

In view of the above conventional examples, it is an object of the present disclosure to simplify the arrangement of an image forming apparatus provided with a conveyance unit.

### SUMMARY

An image forming apparatus according to an aspect of the present disclosure that achieves the above object includes an apparatus body, a conveyance unit and a driving mechanism. The apparatus body has an image forming section which performs an image formation for a sheet, while conveying the sheet along a conveyance route. The conveyance unit which is withdrawably mounted on the apparatus body, the conveyance unit including a housing, a sheet conveyance path formed in the housing and constituting a part of the conveyance route, and a conveyance member which gives a conveyance force to the sheet passing the sheet conveyance path. The driving mechanism which is disposed in the apparatus body generates a driving force for driving the conveyance member. In this arrangement, the conveyance unit has a power transmission member for transmitting the driving force generated by the driving mechanism to the conveyance member. The power transmission member has a drive input section which is disposed on an outside of the housing and receives an input of the driving force. The driving mechanism has a drive output section which is disposed on a side of the apparatus body in correspondence to a mounted position of the conveyance unit with respect to the apparatus body, and which is engageable with the drive input section. The drive input section and the drive output section engage with each other in a mounted state that the conveyance unit is mounted on the apparatus body, and the engagement between the drive input section and the drive output section is released in a withdrawn state that the conveyance unit is withdrawn from the apparatus body.

These and other objects, features and advantages of the present disclosure will become more apparent upon reading the following detailed description along with the accompanying drawings.

### BRIEF DESCRIPTION OF THE DRAWINGS

FIG. 1 is a cross-sectional view showing an internal structure of an image forming apparatus embodying the present disclosure.

FIG. 2 is a perspective view of a conveyance unit, and is a diagram showing that an upper guide member is opened in the embodiment of the present disclosure.

FIG. 3 is a perspective view of the conveyance unit when viewed from the bottom side thereof in the embodiment of the present disclosure.

FIG. 4 is a perspective view showing a state that the conveyance unit is mounted on an apparatus body in the embodiment of the present disclosure.

FIG. 5 is a perspective view showing a state that the conveyance unit is withdrawn from the apparatus body in the embodiment of the present disclosure.

FIG. 6 is a perspective view of the apparatus body in a state that the conveyance unit is withdrawn in the embodiment of the present disclosure.

FIG. 7 is a perspective view of the conveyance unit when viewed from the rear side thereof in the embodiment of the present disclosure.

FIG. 8 is a perspective view of a drive input section for a sheet ejecting unit in the embodiment of the present disclosure.

FIG. 9 is an enlarged perspective view of the sheet ejecting unit in the embodiment of the present disclosure.

FIG. 10 is a schematic diagram for describing connection between the conveyance unit and the apparatus body in the embodiment of the present disclosure.

FIG. 11 is a cross-sectional view showing an internal structure of an image forming apparatus as a modification of the embodiment of the present disclosure.

### DETAILED DESCRIPTION

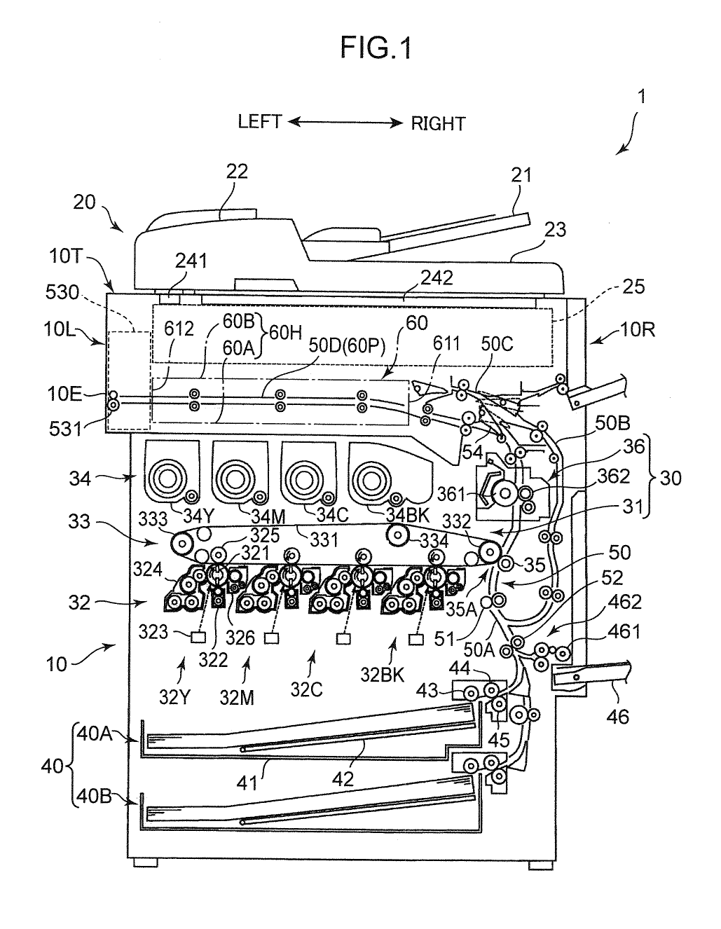

In the following, an embodiment of the present disclosure is described referring to the drawings. FIG. 1 is a cross-sectional view showing an internal structure of an image forming apparatus 1 embodying the present disclosure. In this example, the image forming apparatus 1 is a copying machine. Alternatively, the image forming apparatus may be a printer, a facsimile device, or a complex machine provided with the functions of these devices.

The image forming apparatus 1 is provided with an apparatus body 10 having a substantially rectangular parallelepiped casing structure, and an automatic document feeder 20 to be disposed on the apparatus body 10. The apparatus body 10 is internally provided with a reading unit 25 for optically reading a document image to be copied, an image forming section 30 for performing an image formation for a sheet, a sheet feeding section 40 for storing sheets to be conveyed to the image forming section 30, a conveyance route 50 for conveying the sheets one by one from the sheet feeding section 40 to a sheet ejecting port 10E via the image forming section 30, and a conveyance unit 60 internally formed with a sheet conveyance path constituting a part of the conveyance route 50.

The automatic document feeder 20 is pivotally mounted on the top surface of the apparatus body 10. The automatic document feeder 20 automatically feeds a document sheet to be copied toward a predetermined document reading position (a mounted position of a first contact glass 241) of the apparatus body 10. When the user manually places a document sheet onto a predetermined document reading position (a disposed position of a second contact glass 242), the automatic document feeder 20 is opened upward. The automatic document feeder 20 includes a document tray 21 on which a document sheet or sheets are placed, a document conveyance section 22 for conveying the document sheet(s) via the automatic document reading position, and a document ejecting tray 23 on which the document sheet(s) after image reading are ejected.

The reading unit 25 optically reads an image of a document sheet through the first contact glass 241 for reading an image of a document sheet to be automatically fed from the automatic document feeder 20 disposed on the top surface of the apparatus body 10, or through the second contact glass 242 for reading an image of a document sheet to be placed manually by the user. The reading unit 25 houses therein a scanning mechanism including a light source, a moving carriage, and a reflection mirror; and an image sensor, all of which are not shown. The scanning mechanism irradiates light onto a document sheet, and guides the light reflected on the document sheet to the image sensor. The image sensor photoelectrically converts the reflected light into an analog electric signal. The analog electric signal is converted into a digital electric signal by an A/D conversion circuit, and then, is inputted to the image forming section 30.

The image forming section 30 includes an imaging section 31 for generating a toner image and transferring the toner image onto a sheet, and a fixing section 36 for fixing the toner image on the sheet. The imaging section 31 includes an image forming unit 32 having four units 32Y, 32M, 32C, and 32Bk for respectively forming toner images of yellow (Y), magenta (M), cyan (C) and black (Bk), an intermediate transfer unit 33 disposed adjacent to and above the image forming unit 32, and a toner replenishing section 34 disposed above the intermediate transfer unit 33.

Each of the image forming units 32Y, 32M, 32C, and 32Bk includes a photosensitive drum 321, and a charger 322, an exposure device 323, a developing device 324, a primary transfer roller 325 and a cleaning device 326, which are disposed in the periphery of the photosensitive drum 321.

The photosensitive drum 321 rotates about the axis thereof, and forms an electrostatic latent image and a toner image on the circumferential surface thereof. An example of the photosensitive drum 321 is a photosensitive drum using an amorphous silicon (a-Si)-based material. The charger 322 uniformly charges the surface of the photosensitive drum 321. The exposure device 323 has a laser light source and an optical device such as a mirror and a lens, and forms an electrostatic latent image by irradiating light on the circumferential surface of the photosensitive drum 321, based on image data of a document image.

The developing device 324 supplies toner to the circumferential surface of the photosensitive drum 321 for developing an electrostatic latent image formed on the photosensitive drum 321. The developing device 324 is adapted for supplying a two-component developer, and includes an agitation roller, a magnetic roller, and a developing roller. The agitation roller circulates and conveys a two-component developer while agitating the two-component developer to thereby charge the toner. By performing the above operation, a two-component developer layer is deposited on the circumferential surface of the magnetic roller, and a toner layer formed by transferring the toner by an electric potential difference between the magnetic roller and the developing roller is deposited on the circumferential surface of the developing roller. The toner on the developing roller is supplied to the circumferential surface of the photosensitive drum 321, whereby the electrostatic latent image is developed.

The primary transfer roller 325 forms a nip portion with the photosensitive drum 321, with an intermediate transfer belt 331 provided in the intermediate transfer unit 33 being interposed, for transferring a toner image on the photosensitive drum 321 onto the intermediate transfer belt 331. The cleaning device 326 has a cleaning roller, and cleans the circumferential surface of the photosensitive drum 321 after toner image transfer.

The intermediate transfer unit 33 is provided with the intermediate transfer belt 331, a drive roller 332, a driven roller 333 and a tension roller 334. The intermediate transfer belt 331 is an endless belt which is wound around the rollers 332, 333, 334; and a toner image is laid one over the other onto the outer circumferential surface of the intermediate transfer belt 331 from the plurality of photosensitive drums 321 (primary transfer). The drive roller 332 is a roller to which a driving force for circulating the intermediate transfer belt 331 is applied, and a secondary transfer roller 35 is disposed at a position opposing the circumferential surface of the drive roller 332. A nip portion between the drive roller 332 and the secondary transfer roller 35 serves as a secondary transfer section 35A for transferring a full-color toner image obtained by laying the color toner images one over the other on the intermediate transfer belt 331 onto a sheet. The driven roller 333 is a roller that is driven in accordance with the circulation of the intermediate transfer belt 331, and the tension roller 334 is a roller for giving a predetermined tension force to the intermediate transfer belt 331.

The toner replenishing section 34 includes a yellow toner container 34Y, a magenta toner container 34M, a cyan toner container 34C, and a black toner container 34Bk. These toner containers 34Y, 34C, 34M, 34Bk respectively store toners of the corresponding colors, and supply the toners of the corresponding colors to the developing devices 324 of the image forming units 32Y, 32M, 32C, 32Bk respectively corresponding to the colors of YMCBk through an unillustrated supply route.

The fixing section 36 includes a fixing roller 361 having a fixing belt which is heated by an inductive heating system and provided on the outer circumference thereof, and a pressure roller 362 which forms a fixing nip portion by being pressed against the fixing roller 361. A sheet having a toner image thereof being subjected to secondary transfer in the secondary transfer section 35A passes through the fixing nip portion for being heated and pressurized, whereby the toner image is fixed onto the sheet surface.

The sheet feeding section 40 is provided with two sheet cassettes i.e. 40A, 40B which are stacked one over the other for storing sheets for image formation therein. The sheet cassettes 40A, 40B are withdrawable in a forward direction from the front side of the apparatus body 10. The sheets cassettes 40A, 40B are cassettes designed for automatic sheet feeding, and a sheet feeding tray 46 for manual feeding is provided on a right side surface 10R of the apparatus body 10. The sheet feeding tray 46 is mounted on the apparatus body 10 at a lower end of the sheet feeding tray 46 to be openable and closable. When a sheet or sheets are manually fed, the user opens the sheet feeding tray 46 as illustrated in FIG. 1, and places the sheet(s) on the sheet feeding tray 46.

The sheet cassette 40A (40B) is provided with a sheet storage section 41 for storing a sheet stack constituted of a stack of sheets, and a lifting plate 42 for lifting the sheet stack for sheet feeding. A pickup roller 43, and a pair of rollers constituted of a sheet feeding roller 44 and a retard roller 45 are disposed at an upper position on the right end side of the sheet cassette 40A (40B). By driving the pickup roller 43 and the sheet feeding roller 44, the sheets of the sheet stack in the sheet cassette 40A are dispensed one by one from an uppermost sheet thereof, and are conveyed to the upstream end of the conveyance route 50. On the other hand, the sheets placed on the sheet feeding tray 46 are conveyed into the conveyance route 50 by driving a pickup roller 461 and a sheet feeding roller 462.

The conveyance route 50 includes a main conveyance path 50A for conveying a sheet from the sheet feeding section 40 to the exit of the fixing section 36 via the imaging section 31; a reverse conveyance path 50B for returning a sheet after a one-side printing to the imaging section 31 for performing a double-sided printing for the sheet; a switchback conveyance path 50C for directing a sheet from the downstream end of the main conveyance path 50A to the upstream end of the reverse conveyance path 50B; and a horizontal conveyance path 50D for horizontally conveying a sheet from the downstream end of the main conveyance path 50A to the sheet ejecting port 10E formed in a left side surface 10L of the apparatus body 10. A main part of the horizontal conveyance path 50D is constituted of a sheet conveyance path 60P formed in the conveyance unit 60.

A registration roller pair 51 is disposed at an upstream side of the main conveyance path 50A with respect to the secondary conveyance section 35A. A sheet whose conveyance is temporarily stopped by the registration roller pair 51, and which is subjected to skew correction, is fed to the secondary conveyance section 35A at a predetermined timing for image transfer. A plurality of conveyance rollers 52 for conveying a sheet are disposed in the main conveyance path 50A, in addition to the above-mentioned rollers. The same arrangement as described above is applied to the conveyance paths 50B, 50C, 50D.

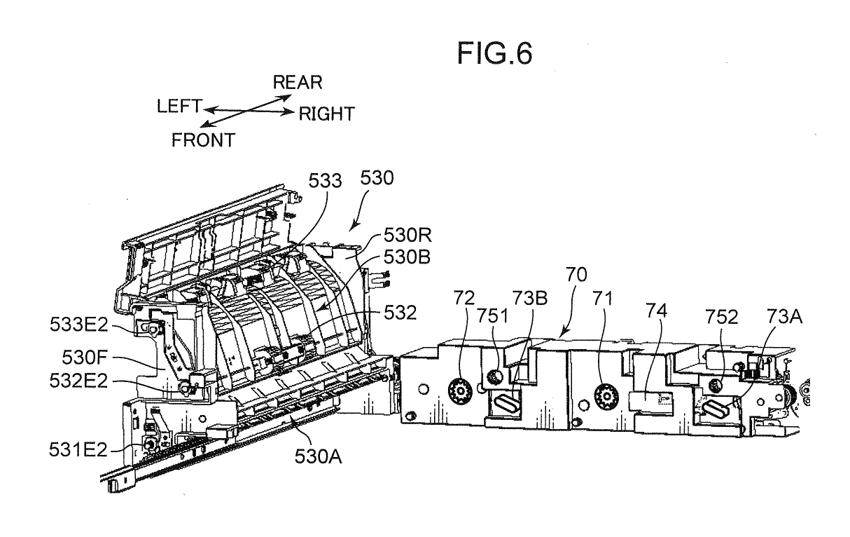

A sheet ejecting unit 530 provided with a sheet ejecting roller 531 is disposed at a most downstream end of the conveyance route 50 at a position adjacent to the conveyance unit 60. The sheet ejecting roller 531 feeds a sheet to an unillustrated post-processing device disposed on the left side surface 10L of the apparatus body 10 through the sheet ejecting port 10E. In the case where a post-processing device is not mounted on the image forming apparatus, a sheet ejecting tray is disposed at a position below the sheet ejecting port 10E. Although not shown in FIG. 1, the sheet ejecting unit 530 is internally formed with a horizontal conveyance path 530A provided with the sheet ejecting roller 531, and a branch conveyance path 530B which is branched out at a position above the horizontal conveyance path 530A for discharging a sheet through an unillustrated sheet ejecting port formed at a position above the sheet ejecting port 10E (see FIG. 6).

The conveyance unit 60 is a unit for conveying a sheet to be outputted from the fixing section 36 to the sheet ejecting port 10E. The image forming apparatus 1 of the embodiment is constructed in such a manner that the fixing section 36 (a fixing device) is disposed on the side of the right side surface 10R (a first side surface) of the apparatus body 10, and the sheet ejecting port 10E is disposed on the side of the left side surface 10L (a second side surface) of the apparatus body 10 facing the right side surface 10R. With this arrangement, the conveyance unit 60 horizontally conveys a sheet from the right side surface 10R of the apparatus body 10 toward the left side surface 10L of the apparatus body 10.

The conveyance unit 60 includes a housing 60H constituted of a lower guide member 60A and an upper guide member 60B, and the sheet conveyance path 60P horizontally extending between the lower guide member 60A and the upper guide member 60B. An inlet port 611 for receiving a sheet to be outputted from the fixing section 36 is formed on the right-end side (an upstream end side) of the sheet conveyance path 60P, and an outlet port 612 for feeding out a sheet to the sheet ejecting unit 530 is formed on the left-end side (a downstream end side) of the sheet conveyance path 60P, respectively.

The conveyance unit 60 is mounted on the apparatus body to be withdrawable from the apparatus body 10 in a forward direction (in a direction toward the front side on the plane of FIG. 1) into an accommodation space (a space formed between the reading unit 25 and the toner replenishing section) formed in the apparatus body 10. In the case where a sheet jam has occurred, the user removes a jammed sheet by withdrawing the conveyance unit 60 from the apparatus body 10.

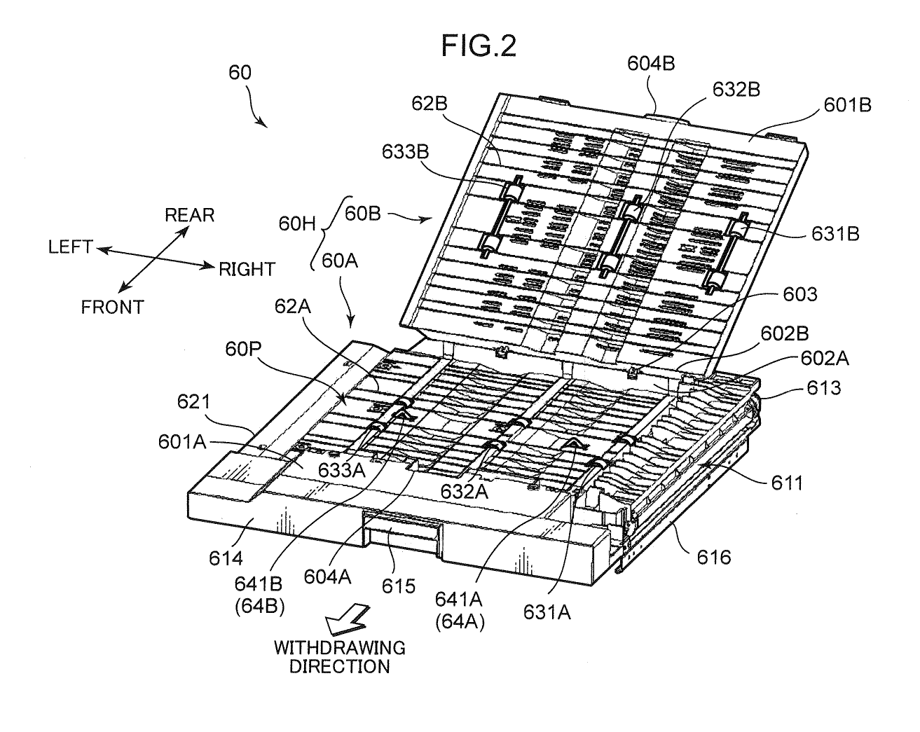

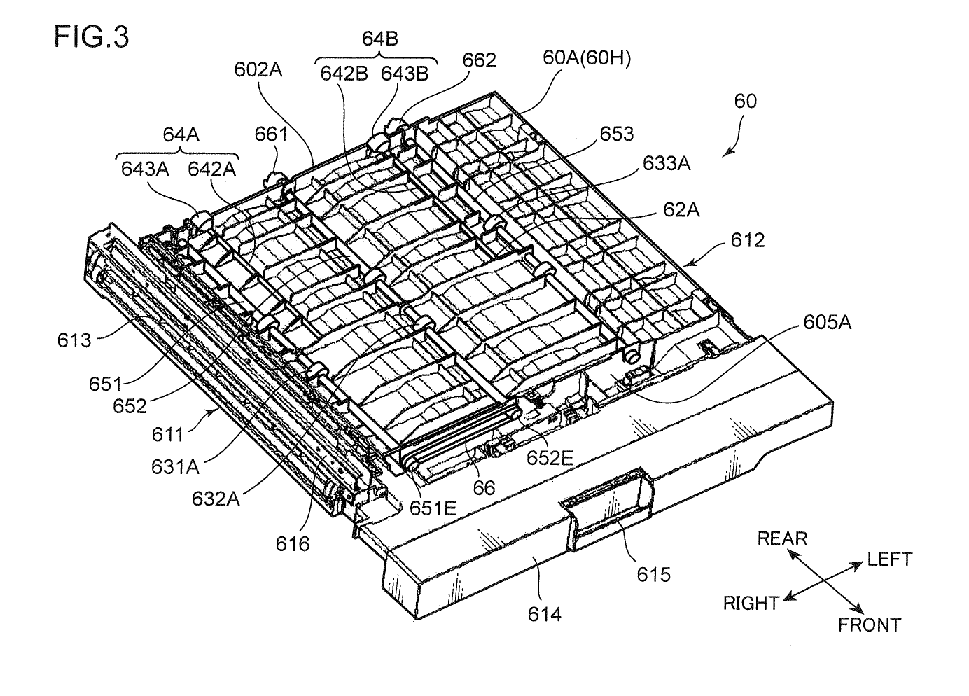

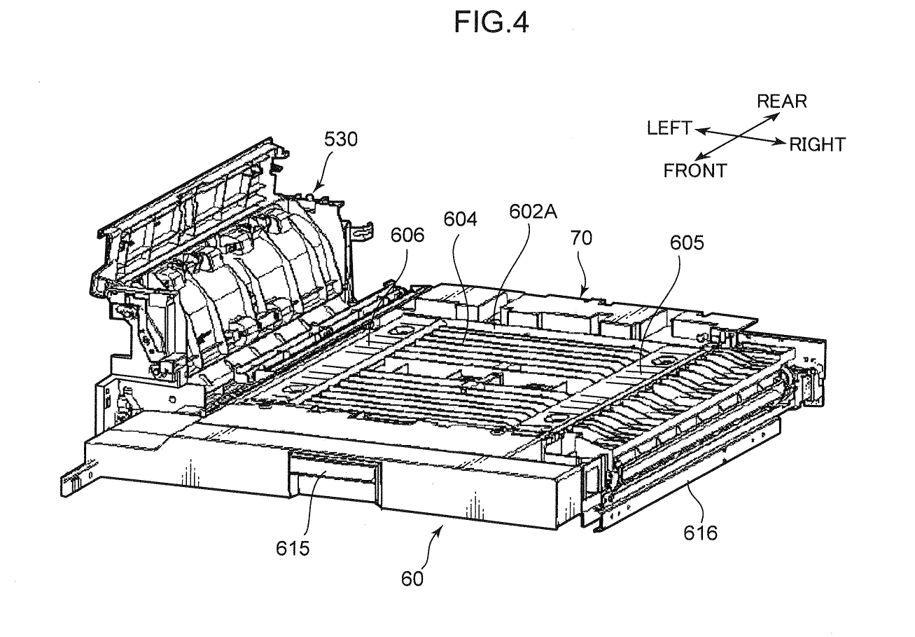

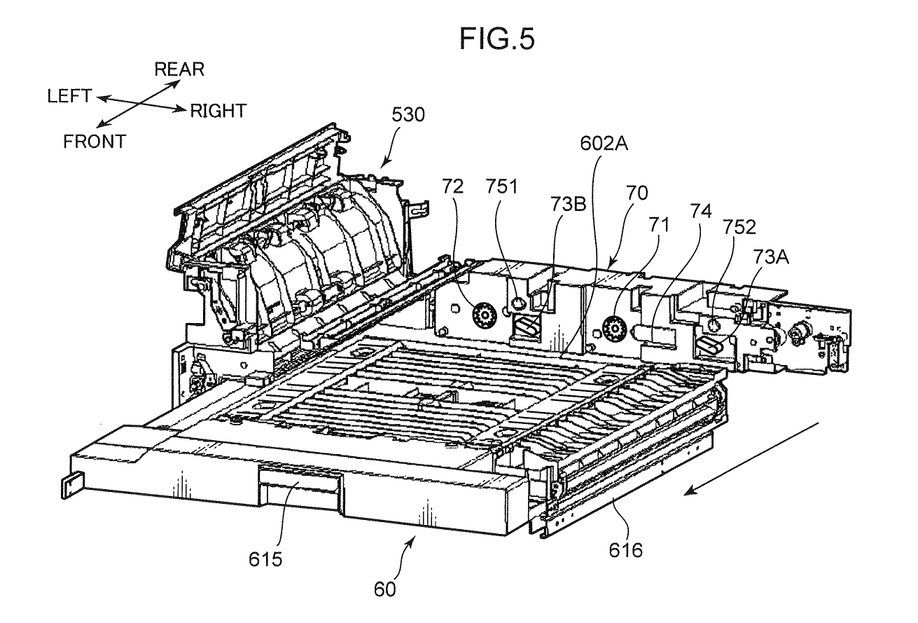

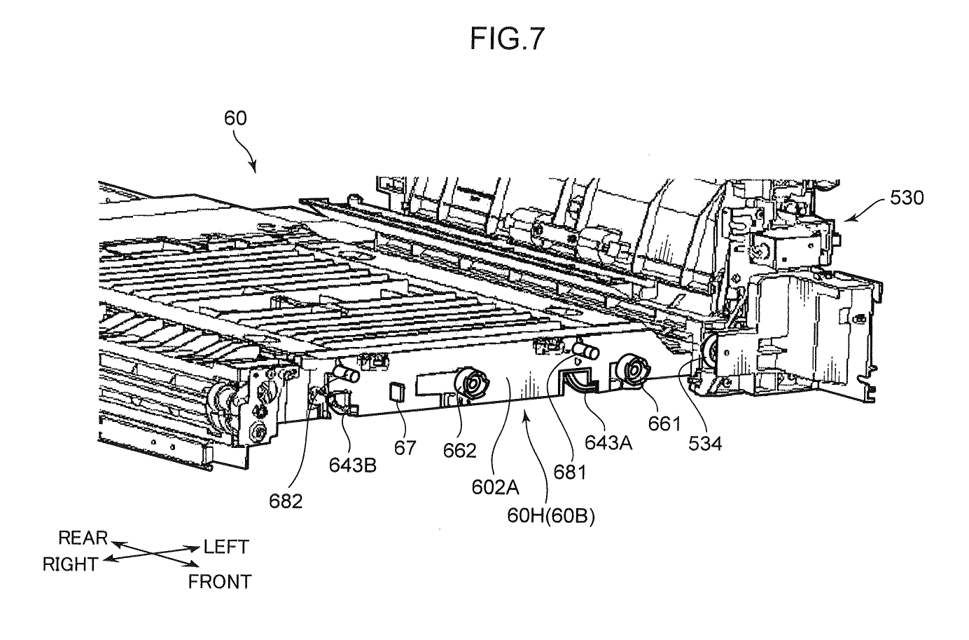

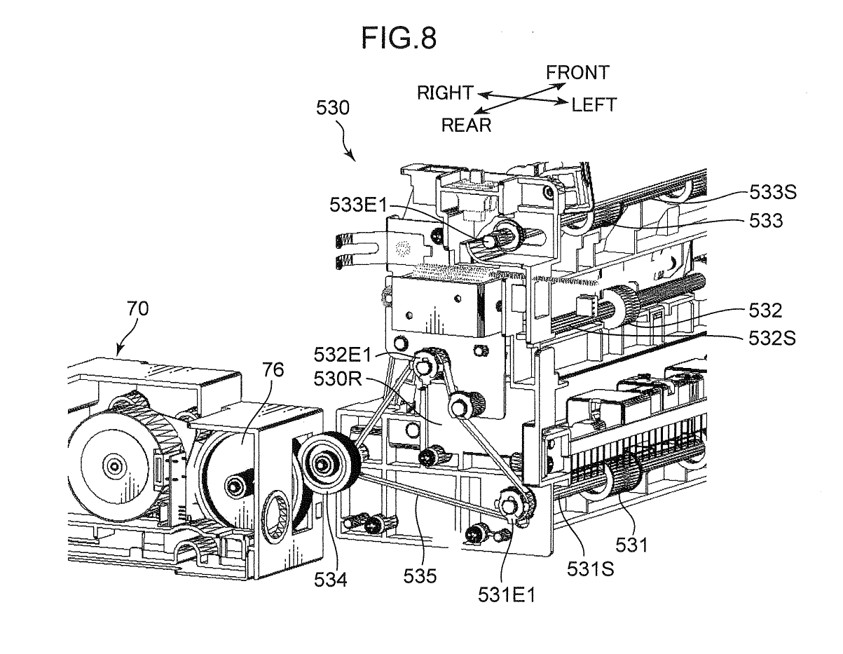

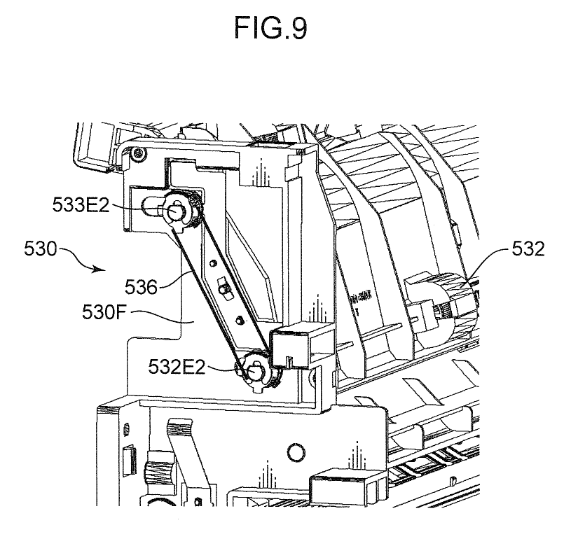

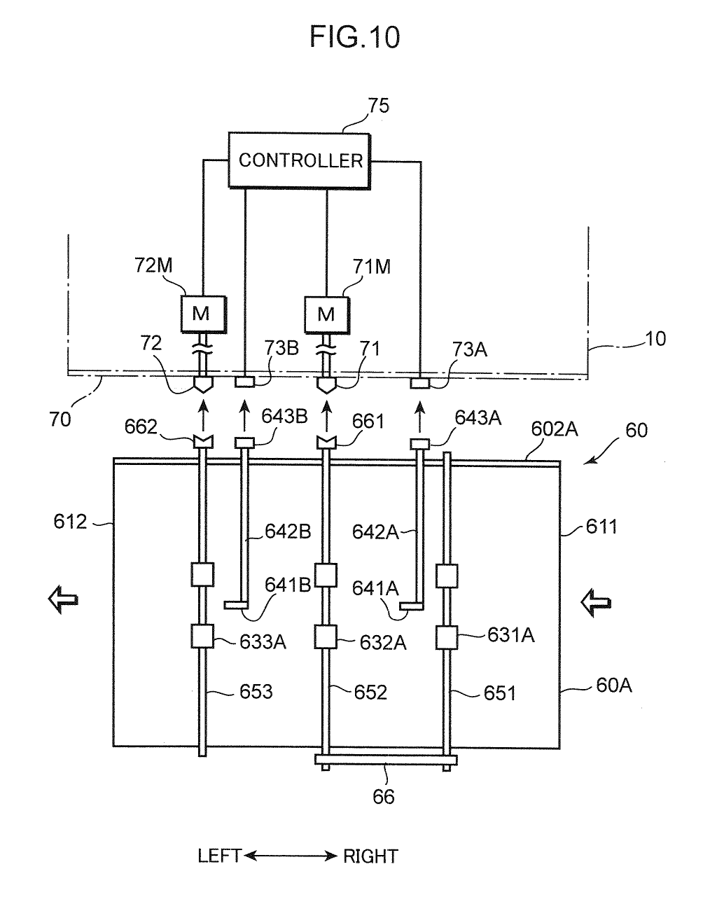

In the following, the arrangement of the conveyance unit and the peripheries thereof will be described in detail referring to FIGS. 2 through 10. FIG. 2 is a perspective view of the conveyance unit 60, and is a diagram showing a state that the upper guide member 60B is opened. FIG. 3 is a perspective view of the conveyance unit 60 when viewed from the bottom side thereof. FIG. 4 is a perspective view showing a state that the conveyance unit 60 is mounted in the accommodation space of the apparatus body 10. FIG. 5 is a perspective view showing a state that the conveyance unit 60 is being withdrawn from the apparatus body 10. FIG. 6 is a perspective view showing a state that the conveyance unit 60 is taken out of the apparatus body 10. FIG. 7 is a perspective view of the conveyance unit 60 when viewed from the rear side thereof. FIG. 8 is a perspective view showing a drive input section for the sheet ejecting unit 530. FIG. 9 is an enlarged perspective view of the sheet ejecting unit 530. FIG. 10 is a schematic diagram for describing connection between the conveyance unit 60 and the apparatus body 10.

Referring to FIG. 2, the lower guide member 60A is formed with a plurality of ribs 62A extending in left and right directions. A tip end edge of each of the ribs 62A serves as a lower guide surface for guiding the lower surface of a sheet to be conveyed in the conveyance unit 60. Likewise, the upper guide member 60B is formed with a plurality of ribs 62B extending in left and right directions. A tip end edge of each of the ribs 62B serves as an upper guide surface. The sheet conveyance path 60P is formed by disposing the lower guide surface and the upper guide surface opposite to each other by a predetermined gap.

The upper guide member 60B is pivotally connected to the lower guide member 60A by a hinge connecting portion 603 on the side of a rear end (at a depthwise portion in the withdrawing direction) of the conveyance unit 60. Specifically, a rear plate 602A of the lower guide member 60A and a rear edge portion 602B of the upper guide member 60B are connected to each other by the hinge connecting portion 603. The lower guide member 60A is a box-shaped member having an opening in the top surface thereof. The housing 60H of the conveyance unit 60 is formed by covering the opening formed in the top surface of the lower guide member 60A by the upper guide member 60B. The upper guide member 60B is housed in the apparatus body 10 in a state that the upper guide member 60B is constantly closed by the lower guide member 60A. When the conveyance unit 60 is withdrawn from the apparatus body 10, the user is caused to grip a handle 604B projecting from a front edge portion 601B of the upper guide member 60B for opening the upper guide member 60B upward. By performing the above operation, in the case where a sheet jam has occurred in the conveyance unit 60, the user is caused to withdraw the conveyance unit 60 from the apparatus body 10, and open the upper guide member 60B, thereby easily removing a jammed sheet.

A decurler device 613 is mounted on the side (the right-end side) of the inlet port 611 of the conveyance unit 60. The decurler device 613 is a device for correcting curls of a sheet which may be formed while the sheet carrying a transferred toner image is heated and pressurized by the fixing section 36. The decurler device 613 includes a rigid roller such as an iron roller and an elastic roller such as a sponge roller, and corrects the curls while the sheet is caused to pass through the nip portion between the rigid roller and the elastic roller.

The lower guide member 60A has a front block 601A at a forward portion of the lower guide surface. The front block 601A is formed with a recess 604A in which the handle 604B is engaged in a state that the upper guide member 60B is closed. A facing block 614 is attached to a position further forward of the front block 601A. A grip 615 with which the user is caused to withdraw the conveyance unit 60 is formed at a generally middle part of the facing block 614 in left and right directions.

Further, a guide rail 616 is attached to each of the right-side lower edge and the left-side lower edge of the lower guide member 60A (the rail attached to the left-side lower edge is not shown). Each of the guide rails 616 is engaged with a counterpart guide rail (not shown) attached to the side of the apparatus body 10 for guiding withdrawal of the conveyance unit 60.

A first conveyance roller 631A, a second conveyance roller 632A, a third conveyance roller 633A (a conveyance member), each of which is constituted of a pair of unit rollers are generally equidistantly arranged on the lower guide member 60A spaced away from each other in left and right directions. A part of the conveyance rollers 631A, 632A, 633A projects upward from a tip end edge of the ribs 62A defining the lower guide surface, and gives a conveyance force to a sheet passing the sheet conveyance path 60P by being applied with a rotational driving force. Driven rollers 631B, 632B, 633B which respectively form a conveyance nip with the conveyance rollers 631A, 632A, 633A are mounted on the upper guide member 60B at positions opposed to the conveyance rollers 631A, 632A, 633A.

Referring to FIG. 3, a first drive shaft 651, a second drive shaft 652, a third drive shaft 653 (a power transmission member) are coaxially and integrally mounted on the first conveyance roller 631A, the second conveyance roller 632A, the third conveyance roller 633A, respectively. The conveyance rollers 631A, 632A, 633A rotate, as the drive shafts 651, 652, 653 rotate about the axes thereof. The driven rollers 631B, 632B, 633B which form the conveyance nip with the conveyance rollers 631A, 632A, 633A are also driven, as the conveyance rollers 631A, 632A, 633A rotate.

A first unit-side coupling 661 and a second unit-side coupling 662 (a drive input section or a first coupling) for receiving an input of a rotational driving force from a first drive motor 71M and a second drive motor 72M (a driving mechanism, see FIG. 10) provided on the side of the apparatus body 10 are attached to the rear end of the second drive shaft 652 and to the rear end of the third drive shaft 653, respectively.

In contrast, a coupling is not attached to the rear end of the first drive shaft 651. A first gear roller 651E is mounted on the front end of the first drive shaft 651, in place of a coupling. Likewise, a second gear roller 652E is mounted on the rear end of the second drive shaft 652. The first and second gear rollers 651E, 652E project outwardly from a front plate 605A of the housing 60H. An endless belt 66 formed with a gear groove in the inner circumferential surface thereof is wound around the gear rollers 651E, 652E. A rotational force of the second drive shaft 652 is transmitted to the first drive shaft 651 via the endless belt 66. By performing the above operation, when a rotational force is supplied to the coupling 661 of the second drive shaft 652, the first drive shaft 651 and the conveyance roller 631A also rotate.

Further, the lower guide member 60A is provided with a first actuator 64A and a second actuator 64B which are disposed away from each other by a certain distance in left and right directions for detecting the presence or absence of a sheet in the sheet conveyance path 60P. The first actuator 64A exclusively detects a sheet jam on the upstream side of the sheet conveyance path 60P, and the second actuator 64B exclusively detects a sheet jam on the downstream side of the sheet conveyance path 60P.

The first actuator 64A includes a sheet detecting piece 641A which changes the posture thereof between a first posture (FIG. 2 shows that the first actuator 64A is in the first posture) that the first actuator 64A protrudes in the sheet conveyance path 60P, and a second posture that the first actuator 64A is inclined by interfering with a sheet passing the sheet conveyance path 60P; a swinging piece 643A which is disposed on the outside of the rear plate 602A (the housing 60H), and which changes the posture thereof in association with the sheet detecting piece 641A; and a connecting rod 642A which connects between the sheet detecting piece 641A and the swinging piece 643A. The connecting rod 642A is pivotally supported by the ribs 62A. The second actuator 64B is provided with a sheet detecting piece 641B, a connecting rod 642B and a swinging piece 643B in the same manner as the first actuator 64A.

A part of the sheet detecting piece 641A protrudes from the tip end edge (the lower guide surface) of the ribs 62A when the sheet detecting piece 641A is in the first posture. When a sheet passes the sheet conveyance path 60P, the sheet presses down the sheet detecting piece 641A to place the sheet detecting piece 641A on the lower guide surface. At the placement, the first actuator 64A swings about the axis of the connecting rod 642A, and the swinging piece 643A also swings in association with the connecting rod 642A. The operation of the second actuator 64B is the same as the operation of the first actuator 64A.

Referring to FIG. 7, the first unit-side coupling 661 and the second unit-side coupling 662, and the swinging piece 643A of the first actuator 64A and the swinging piece 643B of the second actuator 64B are disposed to protrude outwardly from the rear plate 602A which defines a trail end of the housing 60H of the conveyance unit 60. The rear plate 602A is further formed with a ground terminal 67 of the conveyance unit 60, and a pair of guide pins 681, 682 for positioning the conveyance unit 60.

Referring to FIGS. 4 through 6, a depthwise portion of the accommodation space for receiving the conveyance unit 60 of the apparatus body 10 is formed with an opposing wall 70 which faces the rear plate 602A of the conveyance unit 60. When the conveyance unit 60 is mounted on the apparatus body 10 (see FIG. 4), the rear plate 602A and the opposing wall 70 come close to each other. On the other hand, when the conveyance unit 60 is withdrawn from the apparatus body 10 (see FIG. 5 and FIG. 6), the rear plate 602A and the opposing wall 70 are moved away from each other.

The opposing wall 70 is provided with a first body-side coupling 71, a second body-side coupling 72 (a drive output section or a second coupling), a first optical sensor 73A, and a second optical sensor 73B (a detecting member), each of which is constituted of a transmission type photointerruptor, a ground plate 74, and a pair of pin holes 751, 752. Also referring to the schematic diagram of FIG. 10, the apparatus body 10 is further provided with the first motor 71M, the second drive motor 72M respectively connected to the first body-side coupling 71, the second body-side coupling 72, and a controller 75.

The first and second body-side couplings 71, 72 are respectively engaged with the first and second unit-side couplings 661, 662 in a mounted state that the conveyance unit 60 is mounted to a predetermined position of the apparatus body 10. The first motor 71M (a driving mechanism) generates a rotational driving force, and the driving force is transmitted to the second drive shaft 652 via the first body-side coupling 71 and the first unit-side coupling 661 in an engagement state. Further, as described above, the driving force is also transmitted to the first drive shaft 651 via the endless belt 66. The driving force causes the first and second conveyance rollers 631A, 632A to rotate and drive. Likewise, the second motor 72M (a driving mechanism) also generates a rotational driving force, and the driving force is transmitted to the third drive shaft 653 via the second body-side coupling 72 and the second unit-side coupling 662 in an engagement state, whereby the third conveyance roller 633A is rotated and driven. As described above, in this embodiment, the drive input section and the drive output section are configured with a simplified arrangement that the couplings engage with each other in a state that the conveyance unit 60 is mounted on the apparatus body 10, and the engagement between the couplings is released in a state that the conveyance unit 60 is withdrawn. Alternatively, one of the motor 71M and the motor 72M may be omitted, and a driving force may be supplied to the body-side couplings 71, 72 by a belt driving system.

The first optical sensor 73A, the second optical sensor 73B is a sensor for detecting whether a sheet has passed the sheet conveyance path 60P or a sheet is jammed in the sheet conveyance path 60P. The first optical sensor 73A, the second optical sensor 73B is provided with a light emitting element which generates test light, a light receiving element which receives the test light, and a light blocking space which is disposed on an optical path between the light emitting element and the light receiving element. When the conveyance unit 60 is in the mounted state, the swinging piece 643A of the first actuator 64A and the swinging piece 643B of the second actuator 64B are caused to enter into the light blocking spaces of the first and second optical sensors 73A, 73B, respectively.

In the above state, when a sheet is about to enter the upstream side of the sheet conveyance path 60P, and the sheet detecting piece 641A of the first actuator 64A interferes with the entering sheet and is inclined from the home position, the swinging piece 643A also swings and the posture thereof is changed. The posture change causes the swinging piece 643A to enter into the light blocking space of the first optical sensor 73A, whereby the optical path is blocked. By performing the above operation, the light receiving element is brought to a state incapable of receiving the test light. Thereafter, when the trail end of the sheet passes the sheet detecting piece 641A, the sheet detecting piece 641A swings by the gravitational force balance of the first actuator 64A, and the first actuator 64A returns to the home position. The swinging operation causes the swinging piece 643A to retract from the light blocking space, whereby the optical path is released from the light blocking state. Thereafter, the light receiving element is brought to a state capable of receiving the test light. The second actuator 64B is operated in the same manner as described above.

The controller 75 controls the operations of the first and second motors 71M, 72M, and determines whether a sheet has passed the conveyance unit 60, based on an output from the first and second optical sensors 73A, 73B. When an image formation is performed by the imaging section 31, the controller 75 outputs a drive signal to the first and second motors 71M, 72M at a timing when the sheet is conveyed into the conveyance unit 60. By performing the above operation, the first conveyance roller 631A, the second conveyance roller 632A, and the third conveyance roller 633A are rotated and driven for conveying the sheet.

Further, in the case where the first and second optical sensors 73A, 73B output a signal indicating an on state (a light receiving state) or an off state (a light blocking state) in a short time, the controller 75 determines that the sheet has normally passed the sheet conveyance path 60P. On the other hand, in the case where the off state (a light blocking state) lasts for a period longer than a predetermined threshold value, the controller 75 determines that the sheet is jammed in the sheet conveyance path 60P. In this case, the controller 75 causes the operation panel or a like member to display information for alerting the user of the occurrence of a sheet jam.

The above operation is an operation to be performed in the case where the conveyance unit 60 is in a mounted state with respect to the apparatus body 10. On the other hand, in a withdrawn state that the conveyance unit 60 is withdrawn from the apparatus body 10, the engagement between the first body-side coupling 71 and the first unit-side coupling 661, and the engagement between the second body-side coupling 72 and the second unit-side coupling 662 are released. Further, the swinging pieces 643A, 643B of the first and second actuators 64A, 64B are moved away from the first and second optical sensors 73A, 73B, whereby the swinging pieces 643A, 643B are brought to a state incapable of entering into the light blocking space. However, when the conveyance unit 60 is returned from the withdrawn state to the mounted state after e.g. the user has removed the jammed sheet, the above elements are also returned to the respective original states thereof.

The opposing wall 70 is further provided with a driving force input mechanism for the sheet ejecting unit 530. As shown in FIG. 8, the opposing wall 70 is internally provided with a driving gear 76 which rotates by application of a driving force from either one of the first motor 71M and the second motor 72M (see FIG. 10). The driving gear 76 meshes with an input gear 534 (also see FIG. 7) loaded on the sheet ejecting unit 530.

Referring to FIG. 6, FIG. 8 and FIG. 9, the sheet ejecting unit 530 includes a horizontal conveyance path 530A linearly communicating with the sheet conveyance path 60P in the conveyance unit 60, and a branch conveyance path 530B which is branched out from the horizontal conveyance path 530A above the horizontal conveyance path 530A. The aforementioned sheet ejecting roller 531 is disposed in the horizontal conveyance path 530A. Further, a branch conveyance roller 532 which is disposed near the inlet port of the branch conveyance path 530B, and a branch ejecting roller 533 which is disposed near the sheet ejecting port of the branch conveyance path 530B are provided in the branch conveyance path 530B.

The sheet ejecting roller 531, the branch conveyance roller 532 and the branch ejecting roller 533 are respectively held on shafts 531S, 5325 and 533S. Rear ends 531E1, 532E2 and 533E1 of the shafts 531S, 5325 and 533S are rotatably supported by a rear side plate 530R of the sheet ejecting unit 530. Front ends 531E2, 532E2 and 533E2 of the shafts 531S, 5325 and 533S are rotatably supported by a front side plate 530F of the sheet ejecting unit 530.

The sheet ejecting roller 531, the branch conveyance roller 532 and the branch ejecting roller 533 are rotated by a rotational driving force given from the single driving gear 76. A roller gear is mounted on each of the rear ends 531E1, 532E1 of the shafts 531S, 532S of the sheet ejecting roller 531, the branch conveyance roller 532; and a first belt gear 535 is mounted between the roller gears and a small diametrical portion of the input gear 534. With this arrangement, when a rotational force is given from the driving gear 76 to the input gear 534, the rotational force is transmitted to the shafts 531S, 532S of the sheet ejecting roller 531, the branch conveyance roller 532 by the first belt gear 535. By performing the above operation, the sheet ejecting roller 531 and the branch conveyance roller 532 rotate in a predetermined sheet feeding direction. Likewise, a roller gear is mounted on each of the front ends 532E2, 533E2 of the shafts 532S, 533S of the branch conveyance roller 532, the branch ejecting roller 533; and a second belt gear 536 is mounted between the roller gears. With this arrangement, when the branch conveyance roller 532 rotates, the rotational force of the branch conveyance roller 532 is transmitted to the shaft 533S of the branch ejecting roller 533 by the second belt gear 536. By performing the above operation, the branch ejecting roller 533 rotates in a predetermined sheet feeding direction.

In the image forming apparatus 1 of the embodiment as described above, merely the conveyance member is loaded on the conveyance unit 60, and the driving mechanism which generates a driving force for driving the sheet conveyance member is disposed on the side of the apparatus body 10. Specifically, electrical components such as the first and second motors 71M, 72M, and the first and second optical sensors 73A, 73B are not loaded on the conveyance unit 60, and only the simple mechanical components such as the first, second, third conveyance rollers 631A, 632A, 633A, and the first and second actuators 64A, 64B are loaded on the conveyance unit 60. A driving force to the rollers 631A, 632A, 633A is transmitted by the engagement between the first and second unit-side couplings 661, 662 mounted on the ends of the drive shafts 652, 653, and the first and second body-side couplings 71, when the conveyance unit 60 is in the mounted state with respect to the apparatus body 10. Further, the swinging pieces 643A, 643B of the first and second actuators 64A, 64B substantially function as the light blocking pieces for the first and second optical sensors 73A, 73B when the conveyance unit 60 is in the mounted state.

With the above arrangement, there is no need of providing an electrical wiring for the conveyance unit 60, and there is no need of setting a drawer connector for the apparatus body 10 and the conveyance unit 60. Thus, the above arrangement is advantageous in simplifying the arrangement of the image forming apparatus 1. Further, with no provision of an electrical wiring, a route along which static electricity enters via the conveyance unit 60 is not formed. This is advantageous in providing the image forming apparatus 1 with a countermeasure against static electricity.

Further, the above arrangement is also advantageous as a countermeasure against thermal breakage of the first and second optical sensors 73A, 73B. A sheet heated in the fixing section 36 is caused to pass the sheet conveyance path 60P in the conveyance unit 60. As a result of the above operation, the temperature in the conveyance unit 60 reaches a relatively high temperature. Therefore, if the first and second optical sensors 73A, 73B are configured to be directly loaded on the conveyance unit 60, the first and second optical sensors 73A, 73B may cause thermal breakage. In particular, in the case where the image forming apparatus is configured in such a manner that the conveyance unit is optionally mounted in the sheet ejecting space within the apparatus body after the assembling, a measure for releasing the heat of the conveyance unit 60 may be insufficient, and heat is likely to stagnate in the conveyance unit 60. With the above arrangement, however, since the first and second optical sensors 73A, 73B are disposed on the opposing wall 70 of the apparatus body 10, there is no or less likelihood that the first and second optical sensors 73A, 73B may be affected by the heat of the sheet after image fixation. Thus, the above arrangement is advantageous in preventing thermal breakage of the first and second optical sensors 73A, 73B.

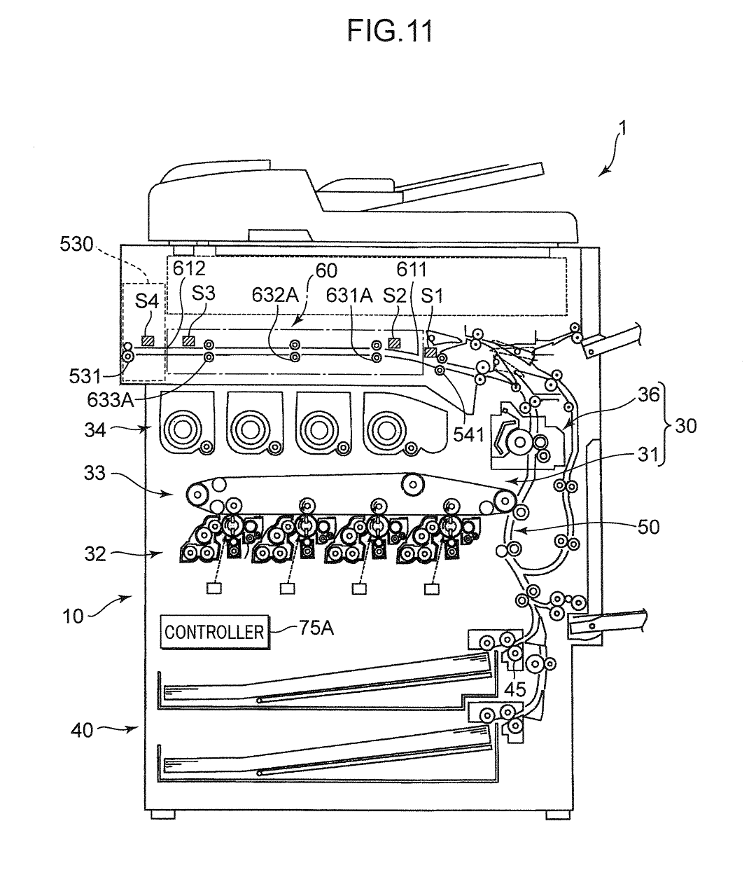

In the following, there is described a modification, in which a measure is provided to cause the user to withdraw a sheet without damaging the sheet as much as possible, in the case where a sheet jam has occurred in the vicinity of the conveyance unit 60. FIG. 11 is a cross-sectional view showing an image forming apparatus 1A as a modification. The arrangement of the image forming apparatus 1A is substantially the same as the arrangement of the image forming apparatus 1 of the embodiment except for a point that a first sheet detecting sensor S1, a second sheet detecting sensor S2, a third sheet detecting sensor S3, and a fourth sheet detecting sensor S4 are disposed in the conveyance unit 60 and the vicinity thereof for detecting the presence or absence of a sheet, and a point that a controller 75A is provided for controlling several conveyance rollers to rotate based on detection results of the first through fourth sheet detecting sensors S1, S2, S3, S4.

An example of the first through fourth sheet detecting sensors S1 through S4 may be a sensor assembled of actuators 64A, 64B and optical sensors 73A, 73B. The first sheet detecting sensor S1 is disposed at a position immediately upstream of a conveyance unit 60 in a conveyance route 50 for a sheet. The second and third sheet detecting sensors S2, S3 are disposed in the conveyance unit 60. Specifically, the second sheet detecting sensor S2 is disposed near an inlet port 611 of the conveyance unit 60, and the third sheet detecting sensor S3 is disposed near an outlet port 612 of the conveyance unit 60. The fourth sheet detecting sensor S4 is disposed in a sheet ejecting unit 530. The first through fourth sheet detecting sensors S1 through S4 output, to the controller 75A, an ON signal when the presence of a sheet is detected, and an OFF signal when the presence of a sheet is not detected.

The controller 75A performs a control of rotating and driving a conveyance roller 541 disposed immediately upstream of the conveyance unit 60, a first conveyance roller 631A, a second conveyance roller 632A, a third conveyance roller 633A in the conveyance unit 60, and a sheet ejecting roller 531 of the sheet ejecting unit 530, as necessary, by referring to output signals from the first through fourth sheet detecting sensors S1 through S4, in the case where a sheet jam has occurred. The above control is performed for the purpose of preventing damage of a sheet, resulting from withdrawing the conveyance unit 60 from the apparatus body 10 in a state that a part of the sheet is placed in the conveyance unit 60 when a sheet jam has occurred.

In the case where a sheet being conveyed is suspended in a region from the side of the inlet port 611 of the conveyance unit 60 to a position near the conveyance roller 541, or a sheet being conveyed is suspended in a region from the side of the outlet port 612 of the conveyance unit 60 to the sheet ejecting unit 530, the controller 75A causes the conveyance roller 541, the first conveyance roller 631A, the second conveyance roller 632A, the third conveyance roller 633A in the conveyance unit 60, and the sheet ejecting roller 531 to rotate and drive for conveying the sheet by a predetermined amount, whereby the sheet is released from a state that the sheet is suspended in a region between two units.

The controller 75A performs the following determinations, based on combination of output signals from the first through fourth sheet detecting sensors S1 through S4:

(A) If the sensor S1=off, and the sensor S3=off, a sheet conveyance is not performed;

(B) if the sensor S1=on, and the sensor S2=off, a sheet conveyance is not performed;

(C) if the sensor S1=on, and the sensor S2=on, a sheet conveyance is performed;

(D) if the sensor S3=on, and the sensor S4=off, a sheet conveyance is not performed; and

(E) if the sensor S3=on, and the sensor S4=on, a sheet conveyance is performed.

In the condition (A), the sheet does not stay near the inlet port 611 or the outlet port 612 of the conveyance unit 60, and stays at a position upstream of the conveyance unit 60 in the conveyance route 50, or within the conveyance unit 60, or within the sheet ejecting unit 530. In this condition, there is no likelihood that the sheet may be damaged, even if the user withdraws the conveyance unit 60. Thus, the controller 75A determines that “a sheet conveyance is not performed”, and does not cause the rollers 541, 631A, 632A, 633A, 531 to drive. In the condition (B), the sheet stays at a forward position of the conveyance unit 60. Also in this condition, there is no likelihood that the sheet may be damaged. Accordingly, the controller 75A determines that “a sheet conveyance is not performed”.

On the other hand, in the condition (C), the sheet stays in a region from the inlet port 611 to a position near the conveyance roller 541. In this case, the controller 75A causes at least the conveyance roller 541 and the first conveyance roller 631A, the second conveyance roller 632A, the third conveyance roller 633A in the conveyance unit 60 to rotate and drive for conveying the sheet by such an amount that the trail end of the sheet passes over the disposed position of the first sheet detecting sensor S1 (in other words, until the sensor S1 is turned off). By performing the above operation, the sheet is fed to a certain position inside the conveyance unit 60. It is needless to say that the sheet may be conveyed up to a position where the sheet completely comes out of the sheet ejecting unit 530.

In the condition (D), the sheet stays in the conveyance unit 60. In this case, there is no likelihood that the sheet may be damaged. Accordingly, the controller 75A determines that “a sheet conveyance is not performed”. On the other hand, in the condition (E), the sheet stays in a region from the outlet port 612 to the sheet ejecting unit 530. In this case, the controller 75A causes at least the first conveyance roller 631A, the second conveyance roller 632A, the third conveyance roller 633A and the sheet ejecting roller 531 to rotate and drive for conveying the sheet by such an amount that the trail end of the sheet passes over the disposed position of the third sheet detecting sensor S3 (in other words, until the sensor S3 is turned off).

Causing the controller 75A to perform the above control is advantageous in preventing damage of a sheet when the conveyance unit 60 is withdrawn in the case where a sheet jam has occurred. In the case where a sheet conveyance is non-executable, for instance, because the jammed sheet has a bellow shape (in this case, the output signals from the sensors S1 through S4 do not change, even if the controller 75A causes the respective parts to perform sheet conveyance control), the controller 75A causes the respective parts to stop the sheet conveyance.

A preferred embodiment of the image forming apparatus of the present disclosure has been described as above. The present disclosure is not limited to the arrangement of the embodiment. For instance, in the embodiment, the conveyance unit 60 is a conveyance unit which horizontally conveys a sheet from the fixing section 36 to the sheet ejecting port 10E. However, there is no limitation as to the portion of the image forming apparatus 1 to which the conveyance unit 60 is applied, or the sheet conveyance direction, and the conveyance unit 60 may be disposed at an appropriate position of the image forming apparatus 1. For instance, the conveyance unit 60 may be applied to a vertical conveyance path, an upwardly inclined conveyance route or a downwardly inclined conveyance route, or a curved conveyance route.

The present disclosure is advantageous in omitting use of an electrical component such as a drawer connector, and simplifying the arrangement of an image forming apparatus provided with a conveyance unit.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

1. An image forming apparatus, comprising:
an apparatus body including an image forming section which performs an image formation for a sheet, while conveying the sheet along a conveyance route;
a conveyance unit which is withdrawably mounted on the apparatus body, the conveyance unit including a housing, a sheet conveyance path formed in the housing and constituting a part of the conveyance route, and a conveyance member which gives a conveyance force to the sheet passing the sheet conveyance path; and
a driving mechanism which is disposed in the apparatus body and generates a driving force for driving the conveyance member, wherein
the conveyance unit has a power transmission member for transmitting the driving force generated by the driving mechanism to the conveyance member, the power transmission member having a drive input section which is disposed on an outside of the housing and receives an input of the driving force,
the driving mechanism has a drive output section which is disposed on a side of the apparatus body in correspondence to a mounted position of the conveyance unit with respect to the apparatus body, and which is engageable with the drive input section,
the drive input section and the drive output section engage with each other in a mounted state that the conveyance unit is mounted on the apparatus body, and
the engagement between the drive input section and the drive output section is released in a withdrawn state that the conveyance unit is withdrawn from the apparatus body.

2. The image forming apparatus according to claim 1, further comprising:
a detecting member which detects a presence or absence of the sheet in the sheet conveyance path, wherein
the conveyance unit includes
a sheet detecting piece which is operable to change a posture thereof between a first posture that the sheet detecting piece protrudes in the sheet conveyance path, and a second posture that the sheet detecting piece is inclined by interfering with the sheet passing the sheet conveyance path, and
a swinging piece which is disposed on the outside of the housing and which is operable to change a posture thereof in association with the sheet detecting piece, and
the detecting member is disposed on a side of the apparatus body in correspondence to the mounted position of the conveyance unit with respect to the apparatus body for detecting the presence of the sheet based on a change in the posture of the swinging piece when the conveyance unit is in the mounted state.

3. The image forming apparatus according to claim 1, wherein
the conveyance member is a conveyance roller,
the power transmission member is a drive shaft of the conveyance roller,
the drive input section is a first coupling which is attached to an end of the drive shaft, and
the drive output section is a second coupling which is engaged with the first coupling.

4. The image forming apparatus according to claim 2, wherein
the detecting member is an optical sensor which detects a change in a state of an optical path based on blocking of the optical path, and
the swinging piece is a light blocking piece which blocks the optical path when the sheet detecting piece is in the first posture or in the second posture.

5. The image forming apparatus according to claim 1, wherein
the image forming section has a fixing device at a position downstream of the conveyance route,
the apparatus body has a box-shaped casing structure, and is formed with a ejecting port for discharging the sheet to an outside of the apparatus body,
the fixing device is disposed on a side of a first side surface of the apparatus body,
the ejecting port is disposed on a side of a second side surface of the apparatus body opposite to the first side surface, and
the conveyance unit conveys the sheet to be outputted from the fixing device horizontally to the ejecting port.

6. The image forming apparatus according to claim 5, wherein
the conveyance unit is provided with a lower guide member forming a lower guide surface of the sheet conveyance path, and an upper guide member forming an upper guide surface of the sheet conveyance path, and
the upper guide member is pivotally connected to the lower guide member at a depthwise portion of the conveyance unit in a withdrawing direction, the upper guide member being openable upward when the conveyance unit is in the withdrawn state.

7. The image forming apparatus according to claim 1, further comprising:
a sheet ejecting unit which is disposed at a most downstream end of the conveyance route, and which is provided with a sheet ejecting roller for discharging the sheet to an outside of the apparatus body, wherein
the sheet ejecting roller is driven by the driving mechanism.

8. The image forming apparatus according to claim 1, further comprising:
a plurality of sheet detecting sensors for detecting a presence or absence of the sheet, the sheet detecting sensors being respectively disposed in an inside of the conveyance unit at an upstream side of the conveyance unit in the conveyance route, and at a downstream side of the conveyance unit in the conveyance route, and
a controller which controls the driving mechanism, wherein the controller determines whether a part of the sheet is placed in the conveyance unit based on a detection result of the sheet by the sheet detecting sensors when a sheet jam has occurred, and controls the driving mechanism to drive the conveyance member for conveying the sheet by a predetermined amount, in the case where it is determined that the part of the sheet is placed in the conveyance unit.
